(19) United States
(12) Patent Application Publication
(10) Pub. No.: US 2025/0270957 A1
(43) Pub. Date: Aug. 28, 2025

(54) FUEL PUMP SYSTEM WITH BUILT-IN THERMAL BYPASS

(71) Applicant: Hamilton Sundstrand Corporation, Charlotte, NC (US)

(72) Inventors: Ryan Prescott Susca, Windsor, CT (US); Ryan Shook, Loves Park, IL (US)

(21) Appl. No.: 18/588,824

(22) Filed: Feb. 27, 2024

(51) Int. Cl. F02C 7/14; F02C 7/232; F23R 3/28

(52) U.S. Cl. CPC F02C 7/14; F02C 7/232; F23R 3/28

(57) ABSTRACT

A fuel delivery system for a gas turbine engine includes a fuel source, and a main fuel pump configured to deliver a first flow of fuel to a combustor assembly of the gas turbine engine. A fuel oil cooler is positioned fluidly between the main fuel pump and the combustor assembly configured to cool oil utilized by the fuel delivery system, and a fuel oil cooler bypass pathway is configured to selectably direct the first flow of fuel to bypass the fuel oil cooler.

### BACKGROUND

Exemplary embodiments pertain to the art of gas turbine engines, and more particularly to fuel delivery systems of gas turbine engines.

Fuel delivery systems for gas turbine engines utilize a variety of pumps, often driven by a gearbox that extracts power from operation of the gas turbine engine to drive the pumps. The pumps include main pumps and an actuation pump. Modern aircraft require more efficient pumping systems and higher running fuel temperatures to improver overall thrust specific fuel consumption (TSFC), which is one measure of operational efficiency of the gas turbine engine and the aircraft.

There is a desire to reduce fuel system gearbox horsepower extraction, but in single engine aircraft it is difficult to move away from inefficient centrifugal main pumps because of their high reliability. These aircraft struggle with satisfying fuel system thermal management requirements at low power conditions when centrifugal pumps are at their most inefficient.

### BRIEF DESCRIPTION

In one exemplary embodiment, a fuel delivery system for a gas turbine engine includes a fuel source, and a main fuel pump configured to deliver a first flow of fuel to a combustor assembly of the gas turbine engine. A fuel oil cooler is positioned fluidly between the main fuel pump and the combustor assembly configured to cool oil utilized by the fuel delivery system, and a fuel oil cooler bypass pathway is configured to selectably direct the first flow of fuel to bypass the fuel oil cooler.

Additionally or alternatively, in this or other embodiments a fuel oil cooler bypass valve is positioned along the fuel oil cooler bypass pathway to control the first flow of fuel along the fuel oil cooler bypass pathway.

Additionally or alternatively, in this or other embodiments the fuel oil cooler bypass valve is one of actively controlled or thermostatically controlled.

Additionally or alternatively, in this or other embodiments a main fuel filter is located upstream of the main fuel pump, and an actuation pump is positioned upstream of the main fuel filter and is configured to deliver a second flow of fuel from the fuel source to one or more actuation devices of the gas turbine engine.

Additionally or alternatively, in this or other embodiments an augmentor fuel pump is positioned upstream of the main fuel filter and is configured to direct a third flow of fuel to an augmentor of the gas turbine engine.

Additionally or alternatively, in this or other embodiments a boost pump is positioned upstream of the main fuel filter and the actuation pump.

Additionally or alternatively, in this or other embodiments the second flow of fuel is urged from the one or more actuation devices to the main fuel filter.

In another exemplary embodiment, a gas turbine engine and fuel delivery system includes a gas turbine engine, including a turbine, and a combustor where a first flow of fuel is combusted to drive the turbine via a flow of combustion products. A fuel delivery system is operably connected to the gas turbine engine and includes a fuel source, and a main fuel pump configured to deliver a first flow of fuel to the combustor. A fuel oil cooler is positioned fluidly between the main fuel pump and the combustor configured to cool oil utilized by the fuel delivery system, and a fuel oil cooler bypass pathway is configured to selectably direct the first flow of fuel to bypass the fuel oil cooler.

Additionally or alternatively, in this or other embodiments a fuel oil cooler bypass valve is positioned along the fuel oil cooler bypass pathway to control the first flow of fuel along the fuel oil cooler bypass pathway.

Additionally or alternatively, in this or other embodiments the fuel oil cooler bypass valve is one of actively controlled or thermostatically controlled.

Additionally or alternatively, in this or other embodiments a main fuel filter is positioned upstream of the main fuel pump, and an actuation pump is positioned upstream of the main fuel filter and is configured to deliver a second flow of fuel from the fuel source to one or more actuation devices of the gas turbine engine.

Additionally or alternatively, in this or other embodiments an augmentor fuel pump is positioned upstream of the main fuel filter and configured to direct a third flow of fuel to an augmentor of the gas turbine engine.

Additionally or alternatively, in this or other embodiments a boost pump is positioned upstream of the main fuel filter and the actuation pump.

Additionally or alternatively, in this or other embodiments the second flow of fuel is urged from the one or more actuation devices to the main fuel filter.

In another exemplary embodiment, a method of operating a fuel delivery system of a gas turbine engine includes urging a first flow of fuel from a fuel source and through a main fuel pump, directing the first flow of fuel from the main fuel pump toward a combustor assembly of the gas turbine engine, directing the first flow of fuel through a fuel oil cooler disposed fluidly between the main fuel pump and the combustor assembly, and selectably flowing the first flow of fuel through a fuel oil cooler bypass pathway to bypass the fuel oil cooler.

Additionally or alternatively, in this or other embodiments a fuel oil cooler bypass valve positioned along the fuel oil cooler bypass pathway is operated to control the first flow of fuel along the fuel oil cooler bypass pathway.

Additionally or alternatively, in this or other embodiments the first flow of fuel is flowed through a main fuel filter positioned upstream of the main fuel pump, and a second flow of fuel is flowed through an actuation pump positioned upstream of the main fuel filter. The actuation pump is configured to deliver the second flow of fuel from the fuel source to one or more actuation devices of the gas turbine engine.

Additionally or alternatively, in this or other embodiments a third flow of fuel is directed through an augmentor fuel pump positioned upstream of the main fuel filter toward an augmentor of the gas turbine engine.

Additionally or alternatively, in this or other embodiments at least the first flow of fuel is flowed through a boost pump positioned upstream of the main fuel filter and the actuation pump.

Additionally or alternatively, in this or other embodiments the second flow of fuel is urged from the one or more actuation devices to the main fuel filter.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a gas turbine engine and fuel delivery system through which fuel is delivered to power the gas turbine engine;

FIG. 2 is a schematic illustration of an embodiment of a fuel delivery system of a gas turbine engine; and

FIG. 3 is a schematic illustration of another embodiment of a fuel delivery system of a gas turbine engine.

### DETAILED DESCRIPTION

A detailed description of one or more embodiments of the disclosed apparatus and method are presented herein by way of exemplification and not limitation with reference to the Figures.

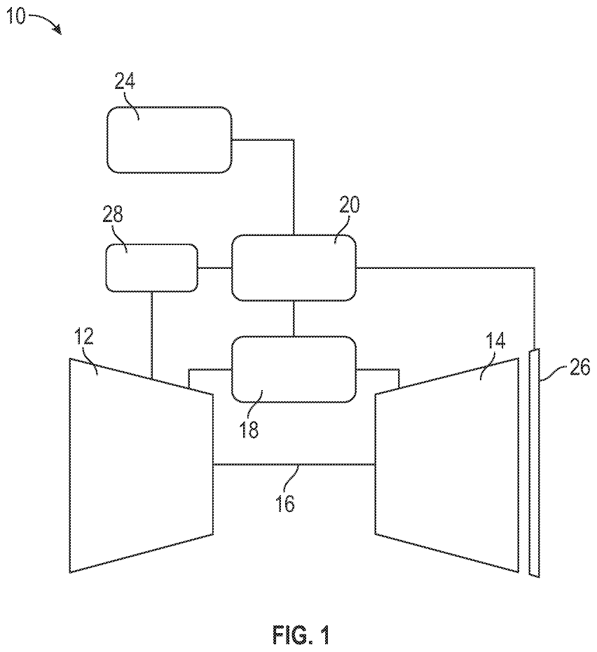

An aircraft gas turbine engine system is indicated generally at 10 in FIG. 1. Gas turbine engine system 10 includes a compressor portion 12 operatively coupled to a turbine portion 14 through a shaft 16. A combustor assembly 18 is fluidically connected between the compressor portion 12 and turbine portion 14. A fuel delivery system 20 fluidically connects the combustor assembly 14 with a source of fuel 24. Fuel delivery system 20 may receive fuel directly from source of fuel 24 or, through a compressor stage (not shown) that creates an input pressure for the fuel. In addition to the combustor assembly 18, the fuel delivery system 20 is operably connected to one or more secondary components, such as an augmentor 26 to deliver a flow of fuel thereto. In some embodiments, a gearbox 28 is operably connected to the gas turbine engine 10 via, for example, the shaft 16 to extract power from the gas turbine engine 10. The fuel delivery system 20 is operably coupled to the gearbox to power components of the fuel delivery system 20.

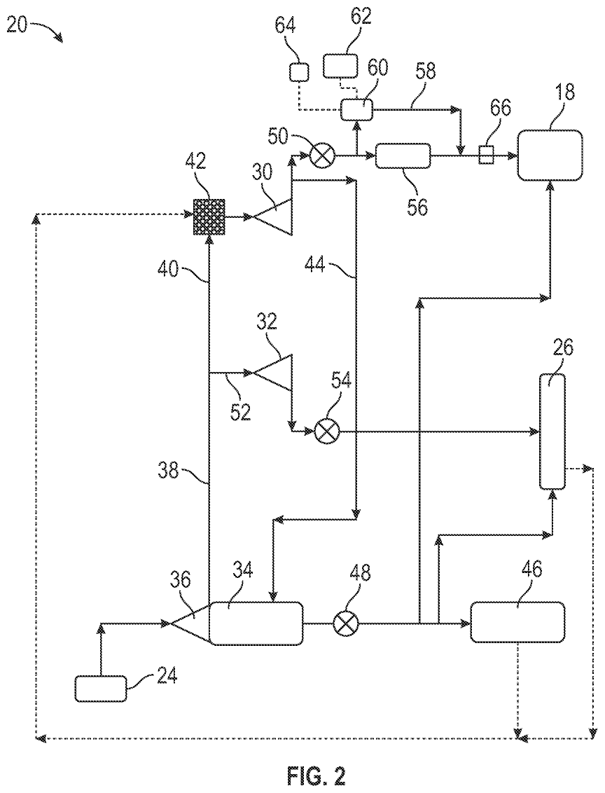

Referring now to FIG. 2, an embodiment of a fuel delivery system 20 will now be described. In the embodiment of FIG. 2, the fuel delivery system 20 is a three-pump fuel delivery system 20, with independently operating main fuel pump 30, augmentor fuel pump 32 and actuation fuel pump 34. Initial a flow of fuel from the fuel source 24 is directed through a boost pump 36 at which the pressure of the flow of fuel is increased. From the boost pump 36, the flow of fuel is directed toward the main fuel pump 30 and the augmentor fuel pump 32 along a fuel pathway 38. A main portion 40 of the flow of fuel flows through a main fuel filter 42 and then through the main fuel pump 30 toward the combustor assembly 18. The flow of the main portion 40 is controlled by one or more main control valves 50. An actuation portion 44 of the flow of fuel, once downstream of the main fuel pump 30, is directed toward the actuation fuel pump 34. The actuation portion 44 is urged toward one or more actuation devices 46 of the fuel delivery system 20 to power the actuation devices 46 at, for example, the combustor assembly 18 and/or the augmentor 26. From the actuation devices 46, the actuation portion 44 is recirculated to the main fuel filter 42, or alternatively to the augmentor fuel pump 32. The flow of the actuation portion 44 is controlled by one or more actuation control valves 48.

Before the main portion 40 reaches the main fuel filter 42, a part of the main portion 40, designated as an augmentor portion 52 of the flow of fuel, is directed toward the augmentor fuel pump 32 and from the augmentor fuel pump 32 toward the augmentor 26. The flow of the augmentor portion 52 is controlled by one or more augmentor control valves 54. Excess fuel of the augmentor portion 52 may be returned from the augmentor 26 to, for example, the augmentor fuel pump 32 or the boost pump 36.

Downstream of the main fuel pump 30 between the main fuel pump 30 and the combustor assembly 18, a fuel oil cooler (FOC) 56 is positioned to cool lubricant utilized by the gearbox 28 and/or pumps 30 and 32 via the flow of the main portion 40 through the FOC 56. For optimal gearbox 28 performance, it is desired that a temperature of the oil is maintained within a preselected range. In some operating conditions of the fuel delivery system 20, however, the FOC 56 may operate to cool the oil such that the temperature of the oil is below the preselected range. To counteract this potential overcooling of the oil, the fuel delivery system includes an FOC bypass pathway 58 that selectably directs the main portion 40 around the FOC 56 so that the main portion 40 does not act to cool the oil at the FOC 56. Flow to the FOC bypass pathway 58 is controlled by operation of an FOC bypass valve 60 located along the FOC bypass pathway 58. The FOC bypass valve 60 may be operated by, for example, an electrohydraulic servo valve 62 and/or a linear variable differential transformer 64 operably connected to the FOC bypass valve 60. In some embodiments, the FOC bypass valve 60 is actively controlled via connected to a temperature sensor 66 that measures a temperature of the oil at the FOC 56, and when the oil temperature falls below the preselected range, the FOC bypass valve 60 is opened, thus directing the main portion 40 along the FOC bypass pathway 58. When the oil temperature returns to within the preselected range, the FOC bypass valve 60 may be signaled to close, thus directing the main portion 40 through the FOC 56.

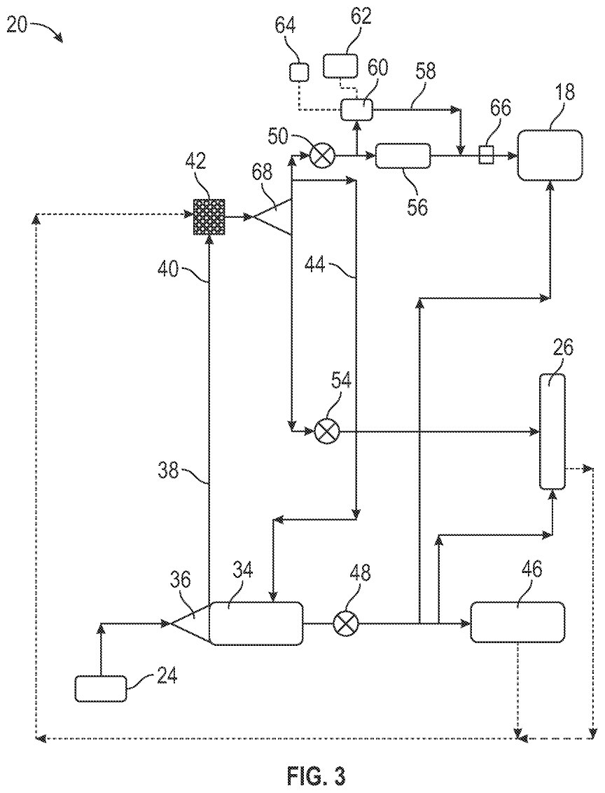

Another embodiment is illustrated in FIG. 3, where the fuel delivery system 20 is a two-pump system having an actuation fuel pump 34 and a combined main fuel pump and augmentor fuel pump 68.

The FOC 56 is located downstream of the combined fuel pump 68 to cool the oil utilized by the gearbox 28 and/or the combined fuel pump 68. Flow to the FOC bypass pathway 58 is controlled by operation of the FOC bypass valve 60 located along the FOC bypass pathway 58. The FOC bypass valve 60 may be operated by, for example, an electrohydraulic servo valve 62 and/or a linear variable differential transformer 64 operably connected to the FOC bypass valve 60. In some embodiments, the FOC bypass valve 60 is actively controlled via connected to a temperature sensor 66 that measures a temperature of the oil at the FOC 56, and when the oil temperature falls below the preselected range, the FOC bypass valve 60 is opened, thus directing the main portion 40 along the FOC bypass pathway 58. When the oil temperature returns to within the preselected range, the FOC bypass valve 60 may be signaled to close, thus directing the main portion 40 through the FOC 56.

Utilization of the FOC bypass pathway 58 and the FOC bypass valve 60 allows for improved control of the temperature of the oil, and prevents overcooling of the oil by the FOC 56. This improved control of the oil temperature improves pump and gearbox performance.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fuel delivery system for a gas turbine engine, comprising:
a fuel source;
a main fuel pump configured to deliver a first flow of fuel to a combustor assembly of the gas turbine engine;
a fuel oil cooler disposed fluidly between the main fuel pump and the combustor assembly configured to cool oil utilized by the fuel delivery system; and
a fuel oil cooler bypass pathway configured to selectably direct the first flow of fuel to bypass the fuel oil cooler.

2. The fuel delivery system of claim 1, further comprising a fuel oil cooler bypass valve disposed along the fuel oil cooler bypass pathway to control the first flow of fuel along the fuel oil cooler bypass pathway.

3. The fuel delivery system of claim 1, wherein the fuel oil cooler bypass valve is one of actively controlled or thermostatically controlled.

4. The fuel delivery system of claim 1, further comprising:
a main fuel filter disposed upstream of the main fuel pump; and
an actuation pump disposed upstream of the main fuel filter and configured to deliver a second flow of fuel from the fuel source to one or more actuation devices of the gas turbine engine.

5. The fuel delivery system of claim 4, further comprising an augmentor fuel pump disposed upstream of the main fuel filter and configured to direct a third flow of fuel to an augmentor of the gas turbine engine.

6. The fuel delivery system of claim 4, further comprising a boost pump positioned upstream of the main fuel filter and the actuation pump.

7. The fuel delivery system of claim 4, wherein the second flow of fuel is urged from the one or more actuation devices to the main fuel filter.

8. A gas turbine engine and fuel delivery system, comprising:
a gas turbine engine, including:
a turbine; and
a combustor where a first flow of fuel is combusted to drive the turbine via a flow of combustion products; and
a fuel delivery system operably connected to the gas turbine engine, including:
a fuel source;
a main fuel pump configured to deliver a first flow of fuel to the combustor;
a fuel oil cooler disposed fluidly between the main fuel pump and the combustor configured to cool oil utilized by the fuel delivery system; and
a fuel oil cooler bypass pathway configured to selectably direct the first flow of fuel to bypass the fuel oil cooler.

9. The gas turbine engine and fuel delivery system of claim 8, further comprising a fuel oil cooler bypass valve disposed along the fuel oil cooler bypass pathway to control the first flow of fuel along the fuel oil cooler bypass pathway.

10. The gas turbine engine and fuel delivery system of claim 8, wherein the fuel oil cooler bypass valve is one of actively controlled or thermostatically controlled.

11. The gas turbine engine and fuel delivery system of claim 8, further comprising:
a main fuel filter disposed upstream of the main fuel pump; and
an actuation pump disposed upstream of the main fuel filter and configured to deliver a second flow of fuel from the fuel source to one or more actuation devices of the gas turbine engine.

12. The gas turbine engine and fuel delivery system of claim 11, further comprising an augmentor fuel pump disposed upstream of the main fuel filter and configured to direct a third flow of fuel to an augmentor of the gas turbine engine.

13. The gas turbine engine and fuel delivery system of claim 11, further comprising a boost pump positioned upstream of the main fuel filter and the actuation pump.

14. The gas turbine engine and fuel delivery system of claim 11, wherein the second flow of fuel is urged from the one or more actuation devices to the main fuel filter.

15. A method of operating a fuel delivery system of a gas turbine engine, comprising:
urging a first flow of fuel from a fuel source and through a main fuel pump;
directing the first flow of fuel from the main fuel pump toward a combustor assembly of the gas turbine engine;
directing the first flow of fuel through a fuel oil cooler disposed fluidly between the main fuel pump and the combustor assembly; and
selectably flowing the first flow of fuel through a fuel oil cooler bypass pathway to bypass the fuel oil cooler.

16. The method of claim 15, further comprising operating a fuel oil cooler bypass valve disposed along the fuel oil cooler bypass pathway to control the first flow of fuel along the fuel oil cooler bypass pathway.

17. The method of claim 15, further comprising:
flowing the first flow of fuel through a main fuel filter disposed upstream of the main fuel pump; and
flowing a second flow of fuel through an actuation pump disposed upstream of the main fuel filter, the actuation pump configured to deliver the second flow of fuel from the fuel source to one or more actuation devices of the gas turbine engine.

18. The method of claim 17, further comprising directing a third flow of fuel through an augmentor fuel pump disposed upstream of the main fuel filter toward an augmentor of the gas turbine engine.

19. The method of claim 17, further comprising flowing at least the first flow of fuel through a boost pump positioned upstream of the main fuel filter and the actuation pump.

20. The method of claim 17, further comprising urging the second flow of fuel from the one or more actuation devices to the main fuel filter.
